(19) United States
(12) Patent Application Publication
(10) Pub. No.: US 2020/0362822 A1
(43) Pub. Date: Nov. 19, 2020

(54) SYSTEM FOR PRODUCING, USING AND STORING GREEN ENGERY

(71) Applicant: Bernard Rusiniak, Depew, NY (US)

(72) Inventor: Bernard Rusiniak, Depew, NY (US)

(21) Appl. No.: 15/931,712

(22) Filed: May 14, 2020

Related U.S. Application Data
(60) Provisional application No. 62/849,445, filed on May 17, 2019.

(51) Int. Cl. F03D 9/17; F03D 9/25

(52) U.S. Cl. CPC F03D 9/17; F03D 9/25

(57) ABSTRACT

A system for generating and storing energy until needed without the use of electricity, the need for banks of batteries or the electrical power grid. The system includes at least one wind energy converter driving, at least one compressor for compressing air. In addition, the system includes, at least one storage device for storing the compressed air, and at least one an air generator driven by the stored compressed to produce clean green electricity, wherein the need for electricity and electrical appliances is eliminated. In addition, the system further includes at least one air-driven device driven by the compressed air where the air-driven device is an air motor or air tools.

### CROSS-REFERENCE TO RELATED APPLICATIONS

This Application claims the benefit of Provisional Application No. 62/849,445 filed May 17, 2019.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

This invention relates to energy generation devices. Specifically, and not by way of limitation, the present invention relates to a system and method of generating and storing energy using a wind energy converter and stored compressed air.

The background information discussed below is presented to better illustrate the novelty and usefulness of the present invention. This background information is not admitted prior art.

The generation and storage of energy is very important in today's world. It is becoming more common for energy users to desire being off-grid. This occurs for various reasons, such as being located in rural areas where there is no commercially available electricity. There are also the situations when conventional energy sources, such as electricity provided by local electric companies is unavailable for a variety of reasons, such as natural catastrophes, weather related disruption, etc. And, there are those who desire the independence of being off-grid. Gas-run generators provide a secondary source of energy but require the user to obtain gas to run the generator. Oftentimes, the availability of gas is also not readily available. Thus, wind generation is often a reliable source of generating electrical power, but there are several inherent problems in the way this is done currently.

Two common sources of using wind power to produce other types of energy are windmills and wind turbines. Early on windmills converted wind energy into rotational energy, while the wind turbine is known to use motion so that electric current can be created. In comparison to the wind turbine, windmills are much smaller. Dating back to the 1300s, they are also a much older form of wind technology. The American windmill, or wind engine, invented by Daniel Halladay in 1854, was used mostly for lifting water from wells. Larger versions were also used for tasks such as sawing wood, chopping hay, and shelling and grinding grain. In early California and some other states, the windmill was part of a self-contained domestic water system which included a hand-dug well and a wooden water tower supporting a redwood tank enclosed by wooden siding known as a tankhouse. During the late 19th century steel blades and steel towers replaced wooden construction. These windpumps are used extensively on farms and ranches in the United States, Canada, Southern Africa, and Australia. Today, nearly six million mills help supply American wind energy.

When the wind blows, the windpump blades catch the air and start to turn. The blades are attached to an axle, which in turn is connected to either a pump or gears. They feature a large number of blades, so they turn slowly with considerable torque in low winds and are self-regulating in high winds. A tower-top gearbox and crankshaft convert the rotary motion into reciprocating strokes carried downward through a rod to the pump cylinder below.

The use of small windmills for electric generation was not a difficult transition from windpumps for farmers and ranchers, given the longtime success of mechanical water-pumping windpumps. During the early 1900s, small windmills produced 5 kW to 25 kW of power. They were used throughout the rural United States to provide electricity to remote locations. Windmills are now used to generate electricity for home use in suburban areas, as well. Most small wind turbines suitable for home use are horizontal-axis fixed-blade three-phase permanent magnet systems. The rotation of their rotor varies with air speeds and therefore produces AC voltage with variable amplitude and frequency. This voltage, however, is not directly usable by conventional household electrical appliances. It has to be rectified and then converted into a regulated constant-frequency AC compatible with the utility power. The conversion is done by a solid-state inverter, which operates as a switch mode power supply (SMPS).

Gearless wind turbines (also referred to as direct drive; a term that should not be confused with the “direct drive device” of the present invention) completely eliminate the gearbox. Instead, the rotor shaft is attached directly to the generator, which spins at the same speed as the blades.

In general, there are three basic types of electric renewable energy power systems: Off grid, Grid-tie, and Grid-tie with battery backup. Stand-alone (or off-grid) systems operate independent of the electric utility grid. Current wind turbines can not store energy and they are able to generate electricity only when there is sufficient air movement. Thus, for continuous power flow for home use, the generated energy has to be stored in batteries. Due to erratic energy flow from the turbines, however, the battery bank must be significantly oversized unless the installation has another power source. To reduce their size, off-grid wind systems are normally supplemented by solar electric systems or by auxiliary generators that are fueled from diesel or propane tanks.

Grid-Tied setups are connected parallel to existing electric service. The energy they generate is fed directly into the household wiring, which reduces the electricity consumption from the utility. However, this setup requires special grid tie inverters to synchronize its operation with the mains. When the power produced by the turbine is greater than what is needed, the inverter will send the surplus to the grid. This type of battery-less system does not provide back up during blackouts even when there is a sufficient air flow. The frequency of the inverter in such a system is set by the power line. During a power outage the inverter gets no reference voltage to operate. In addition, it is required to automatically disconnect from your wiring in order to prevent back-feeding into “dead” utility lines.

Grid-Tied systems with battery backup use special grid-tie inverters with an additional built-in transfer relay. They can reduce utility bills similarly to grid tie systems. Under normal conditions, a portion of the energy in such systems is used to keep the storage batteries charged. During a blackout, the transfer switch will automatically disconnect the grid to continue powering the whole house or selected loads from the energy accumulated in the battery bank. The wiring routed from the turbine down the tower goes to the tower base junction box, from which you can run a cable to the home entrance junction box, and then to the rectifier, an inverter and possibly an optional battery charger. Some residential-grade turbines rectify the output AC voltage at the tower top, and supply it down as DC.

### SUMMARY

In short, the invention is a system for generating and storing energy until needed, without the use of electricity, without the need for banks of batteries or without the need for the electrical power grid. The system includes at least one wind energy converter driving, at least one compressor for compressing air. In addition, the system includes, at least one storage device for storing the compressed air, and at least one an air generator driven by the stored compressed to produce clean green electricity, wherein the need for electricity and electrical appliances is eliminated. In addition, the system further includes at least one air-driven device driven by the compressed air where the air-driven device is an air motor or air tools.

In one aspect, the present invention is a system for generating and storing energy. The system includes a wind energy converter that collects the kinetic energy of the wind to drive a compressor for compressing air, thus forming potential energy. In addition, the system includes a storage facility for storing the compressed air. The potential energy of the compressed air in storage is used to drive various forms of air motors and air tools, as well as driving an air generator providing electricity.

In another aspect, the present invention is a method of generating and storing energy. The method begins by collecting the kinetic energy of the wind for driving a compressor. Next, the compressor compresses air and stores the compressed air. The stored compressed air is then used to drive various forms of air motors and air tools, as well as driving an air generator providing electricity.

Accordingly, the present inventor devised a set of principles that describe the mechanical simplicity of regenerating electrical or air power and storing power until needed employing a wind energy converter combined with structural elements, such as an air compressor and an air motor or an air generator, to translate wind energy into potential energy, such as the potential energy of compressed air. The compressed air is then stored until needed or used for power or to produce electricity. Used to produce electricity, the compressed air potential energy drives an air generator to produce clean, green electricity. The great beneficial utility of this is when there is no wind to generate power there is always an abundance of the stored potential energy of the pressurized air, as all excess potential energy of the stored compressed air remains in storage available for use, whenever needed. This makes it possible to use a wind energy converter for the production of the green electricity while eliminating the need for a bank of batteries to handle overflow electricity or for the need for the system to be tied to the grid. Additionally, either simultaneously or separately, the potential energy of the compressed air is used for continuous running of air powered devices, such as: air generators, air motors and air machines, that can completely eliminate the need for electric generators, batteries and electric motors. Air motors are often the motor of choice for use in certain industries where safety and/or hygiene could be adversely affected by using an electrical motor, for example in humid, corrosive, explosive or wet environments, or when the immediate working environment must be kept extremely clean or even sterile. Some of the uses for air compressed motors include use in the: Food and Beverage industry such as the meat, cookie, fish and ice cream industry; in the Wine industry; in the Transport industry; in the Nuclear industry, and in the Health industry. Another use for the wind-produced high-pressure compressed air is to produce low-pressure air for use in mechanic's shops. The production of high-pressure air, low-pressure air and electricity from a simple windmill is not exclusive, they may all be produced simultaneously. The invention is especially attractive because of its simplicity, low cost, and its ability to produce electricity when there is and is not any wind, and also to store the wind energy for production of electricity when needed in a green, clean manner or for the generation of energy to power air driven devices.

In conclusion, the invention contains a system for generating and storing energy, comprising: at least one wind energy converter, at least one compressor, at least one storage device, at least one an air generator; such that the at least one wind energy converter drives the at least one compressor to produce compressed air, such that the at least one storage device stores the compressed air, such that the stored compressed air drives an air generator to produce clean green electricity, wherein the need for electricity and electrical appliances is eliminated. The invention also contains a method of generating and storing energy, the method comprising the steps of driving, by at least one wind energy converter, at least one compressor; compressing air by the at least one compressor producing compressed air; storing the compressed air in least one storage device; using the stored compressed air to drive at least one an air generator by the stored compressed air to produce clean green electricity; wherein the need for electricity and electrical appliances is eliminated.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments illustrated in appended drawings where like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a simplified block diagram of an energy generation system in one embodiment of the present invention.

FIG. 2 is a schematic drawing illustrating one embodiment of the principles of the present invention.

FIG. 3 is a schematic drawing illustrating one embodiment of a wind energy converter of the present invention.

### LIST OF REFERENCE NUMERAL AND PARTS TO WHICH THEY REFER

4 Blades.
6 Driveshaft.
8 Air compressor(s).
10 Wind energy converter(s).
12 Air line(s).
14 Air storage facilitie(s).
16 Regulator(s).
18 Tower support.
22 Air generator(s).
24 Air tools
25 Wind vane.
30 Air motor(s).
35 Horizontal axis.
40 L-gear.
42 Storage batteries.
44 Electric power gird.
46 AC uses.
48 DC uses.

### Definitions

Compressor: As used herein, a compressor is a machine that squeezes a gas into a smaller volume and (often) pumps it somewhere else at the same time as. It should be known that the words “pump” and “compressor” are often used interchangeably, although the technical difference is that a pump is a machine that moves a fluid (either liquid or gas) from one place to another.

Compressed air, as used herein, is air kept under a pressure that is greater than atmospheric pressure. Compressed air is an important medium for transfer of energy in industrial processes, and is used for power tools such as air hammers, drills, wrenches and others, as well as to atomize paint, to operate air cylinders for automation, and can also be used to propel vehicles. Brakes applied by compressed air made large railway trains safer and more efficient to operate. Compressed air brakes are also found on large highway vehicles. Compressed air is used as a breathing gas by underwater divers. It may be carried by the diver in a high pressure diving cylinder, or supplied from the surface at lower pressure through an airline or diver's umbilical. Similar arrangements are used in breathing apparatus used by firefighters, mine rescue workers and industrial workers in hazardous atmospheres. In Europe, ten percent of all industrial electricity consumption is to produce compressed air—amounting to 80 terawatt hours consumption per year.

Direct drive device, as used herein, means that the energy from the wind is not converted to electrical energy prior to being conveyed to an air compressor(s).

Driveshaft as used herein, is a mechanical device for transmitting torque and rotation, usually used to connect other components of a drive train that cannot be connected directly because of distance or the need to allow for relative movement between them.

Nacelle: Used in a wind turbine, a nacelle sits on top of the tower to contain main technical parts of a wind turbine, such as low- and high-speed shafts, gearbox, brake and a generator. It also contains a blade pitch control, a hydraulic system that controls the angle of the blades, and a yaw drive, which controls the position of the turbine relative to the wind. It should be noted that a nacelle and the structures it contains are not part of the structure of the windmill of the present invention.

Windmill Windmills and other types of wind energy converters are wind-powered devices that convert wind energy into other types of potential or kinetic energy. Early in their history, the early version of windmills converted wind energy directly into mechanical energy for such tasks as milling grain or pumping water, which is usually the purpose of windmills you see on farms, or for directly producing electricity. The principles of the present invention, however, combine the mechanical simplicity of a wind energy converter to power an air compressor to produce compressed air that can be stored until needed to produce low pressure air for such uses needed by various shops and air engines, as well as to produce electricity, as needed or to power air driven devices, such as air motors and various types of air machines.

Wind Turbine A wind turbine, is usually a commercial device, using the kinetic energy of wind and the mechanisms contained in its nacelle, converts wind energy into electricity, which can then be used to power electrical equipment, stored in batteries or transmitted over power lines.

Wind vane, also called a weather vane, determines wind direction. The wind vane spins and points in the direction from which the wind is coming. The protruding end of the vane is of a width that catches the breeze so that the vane guides the spinning blades mechanism of a wind energy converter, such as a windmill to pivot so that it always faces the wind.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, forms and numbers of components. The wind energy converter can be a horizontal or vertical axis windmill or one of any other wind energy converter's structural designs (see more detail in discussion below). Another example of various embodiments: the number of blades in a windmill may vary, the vane of a windmill can be of any serviceable design and the height of a windmill can be determined by the particular geographic and other circumstances. Also, the air storage tanks, as taught herein, are contemplated to be of any useful size and design and from one to as many as required, similarly, the number of wind-generating machines used to produce a wanted amount of compressed air may vary. Therefore, the embodiments described herein are provided with the understanding that the present disclosure is intended as illustrative and is not intended to limit the invention to the embodiments described herein.

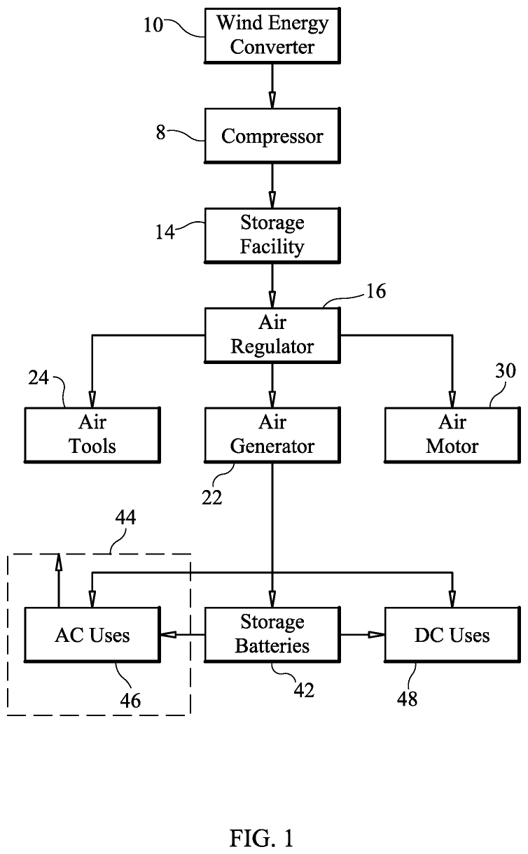

The present invention is a system for generating and storing energy in the form of compressed air, although if desired liquid air could be used, as well. FIG. 1 is a simplified block diagram of an energy generation system in one embodiment of the present invention. The basic system, as illustrated in block diagram form in FIG. 1. includes wind energy converter 10, compressor 8, energy storage facility 14. Additionally, the system includes, if desired or if required for a specific need, air regulator 16, air generator 22, air motor 30 and air tool(s) 20. The energy storage facility preferably includes one or more high pressure tanks which are one way of having accumulators for storing energy.

The core of the present invention is wind energy convertor 10, compressor 8 and energy storage facility 14 that stores and uses energy in the form of pressured air. The present invention is intended to be used a primary source of power. However, the present invention may be used in other applications, such as a backup generator. The system does not produce pollution and it can operate as a standalone system without connection to the power grid 22.

It is well known that both grid-connected and off-grid home renewable energy systems require an investment in some additional equipment (called “balance-of-system”) to condition the electricity, to safely transmit electricity to the load that will use it, and/or to store the electricity for future use. With stand-alone systems—those not connected to the electric grid—the amount of equipment you will need to buy depends on what you want your system to do. In the simplest systems, the current generated by your system is connected directly to the equipment that it is powering (load). However, if you want to store power for use when your system isn't producing electricity, you will need to purchase batteries and a charge controller. Depending on your needs, balance-of-system equipment for a stand-alone system could account for half of your total system costs. Typical balance-of-system equipment for a stand-alone system includes batteries, charge controller, power conditioning equipment, safety equipment, and meters and instrumentation.

Not as well known or appreciated as electric motors are clean, green air motors. The greatest advantage of an air motor vs. electrical motor is the torque. An air motor allows you to adjust the torque output depending on your needs. Some electric motors feature multiple speed settings, but the torque from the motor remains fixed. Unlike an electrical motor, air motors increase or decrease motor torque to meet precise mixing requirements. Air motors create torque by varying the air pressure turning the motor. The more air that is let through, the faster the motor spins with less torque. As the pressure increases, the motor spins slower with more torque. An electric motor does not have this versatility. If the torque is overloaded the motor simply jams and is often damaged. An air motor compensates for increased torque requirements with more air pressure until the need is met. Electric motors are more efficient than air motors. An electric motor provides air pressure directly to the sealed motor box. An air motor relies on external air compression that travels to the motor box. Air motors require tubes, elbows, and fittings that leach air. Even with these small decreases in efficiency, air motors provide many times the output power as electric motors. The energy efficiency of an air motor vs electrical motor makes a big difference for a business's bottom line. The speed at which your motor can run is variable on an air motor. By increasing air pressure to the motor, the speed and torque respond in kind. Electric motors only offer a feature for variable speed control at an upcharge. Air motors work to produce precision results with every use. You can count on the same production quality over the lifecycle of the motor. Electric motors are not as reliable and will decrease in efficiency, over time. One of the biggest considerations to make in your air motor vs electrical motor decision is the environment in which you mean to use it. Some environments are hazardous for electrical motors. Air motors are the first choice when working in an environment where corrosion could take place. The design of electrical motors ensures that the units are explosion-proof. This casing requires motor housing to be placed very tightly together, with little room between parts. The casing of these motors ends up collecting moisture and corroding the moving parts of your electrical motor. An air motor is reliant on pressurized air, instead of moving parts. Air motors are safe to use in wet environments. Electric motors need environmentally controlled housing if they are to be used outdoors. Electric motors include a power source and motor housing all in one unit. Since air motors connect to an external power source, they are much lighter and easier to relocate. And, the power output of an air motor produces more horsepower than that of its electric counterpart. If your torque and power requirements are variable, an air motor is the right choice. On the other hand, electrical motors are much more energy efficient, but at a loss of versatility. The only reason you benefit from an electrical motor is if your usage is static and environment controlled. It is important to note that in Europe alone, ten percent of all industrial electricity consumption is to produce compressed air—amounting to 80 terawatt hours consumption per year. Applicant's invention is to produce compressed air eliminating the need for electricity.

It is critical to know that in industry, compressed air is so widely used that it is often regarded as the fourth utility, after electricity, natural gas and water. Compressed air is used for many purposes, including: pneumatics, the use of pressurized gases to do work, such as: pneumatic post, using capsules to move paper and small goods through tubes, air tools, HVAC control systems, vehicle propulsion; energy storage; air brakes, including: railway braking systems, road vehicle braking systems; underwater diving, for breathing and to inflate buoyancy devices; refrigeration using a vortex tube; air-start systems in engines; ammunition propulsion in: air guns, airsoft and paintball equipment; cleaning dust and small debris in tiny spaces; sandblasting in machine shops; injection molding; food and beverage capping and fermentation, and for compressed air from Lysefjorden/Preikestolen (Norway) that is being sold in cans, mostly to China.

Accordingly, the present, inventor formulated a set of principles that enable multiple types of low-cost, clean and green energy to be produced, used, and stored from a simple, low-cost wind energy converter system (combination) that eliminates the need for balance-of-system equipment. The wind energy converter system, as described by the present invention, drives the production of high-pressure compressed air. The high-pressure compressed air can be used immediately or is stored, such as in compressed air tanks, until needed to be either (1) converted to lower-pressure compressed air for shop or other use or (2) converted into electricity for immediate use when needed, or if desired, to be returned to the grid for rebate, or (3) to power air devices such as air motors and air machines. Thus, the multi-purpose wind energy converter system of the present invention provides for wind energy to be harvested when wind is available, stored during times when energy demand is low and then released at a time when the energy demand increases or when wind energy abates. This provides for those who want to be off-grid to have a system that does not require back-up sources of energy input such as solar or water or to require electricity storage devices, such as battery banks. All of this means that those who desire off grid can have a system of power generation at low cost, without the need for costly and difficult to manage banks of batteries.

The invention includes at least one wind energy converter that, when driven by the wind, provides energy to a high-pressure compressor to compress air to the potential energy of elevated air pressure, such as 5000-6000 pounds for immediate use or to an energy storage device, for storage in, for example, high-pressure cylinders until the potential energy is needed. The compressed air is then lowered in pressure for immediate use in shop or in other jobs requiring lower pressure compressed air, such as farming, manufacturing, and home use. The compressed air can also be used to power an air generator to generate electricity as needed or, alternatively can power wind motors or machines to eliminate any need for electricity. Another embodiment contemplates the invention to be used to power electric or wind engine vehicles, such as trucks, automobiles, lawn mowers and the like. The use of wind motors would be a great addition to the efforts given to creating a CO₂ free atmosphere.

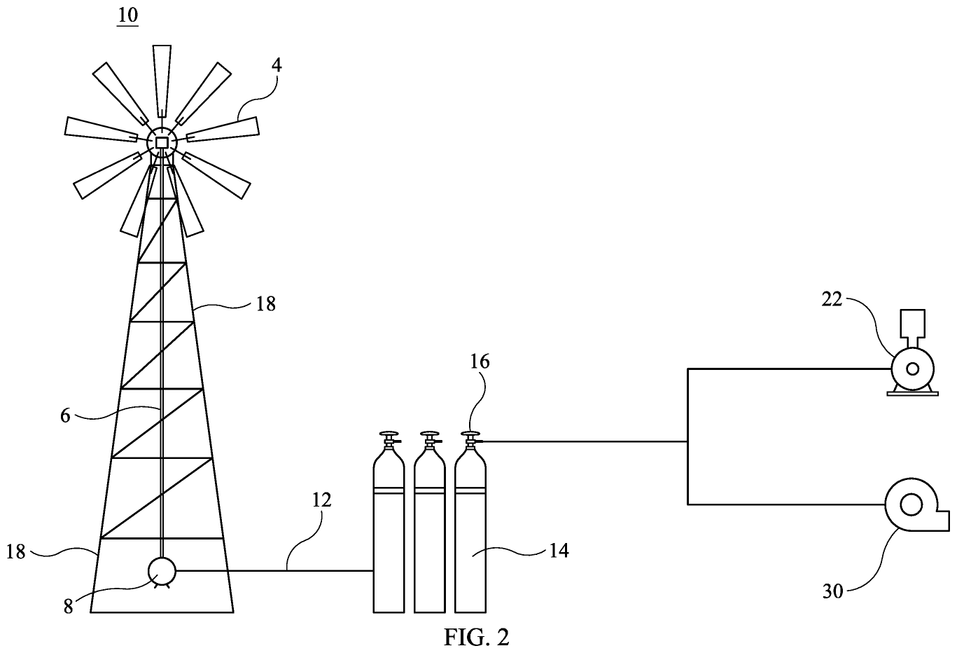

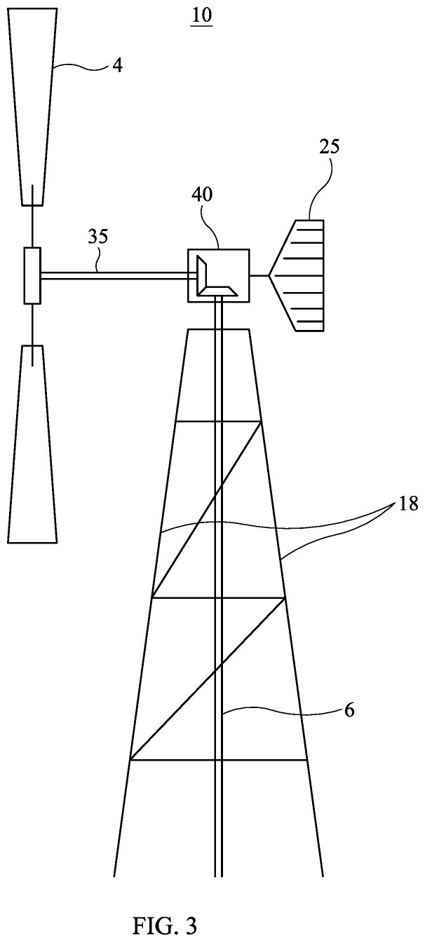

FIG. 2 and FIG. 3 are schematic representations of one embodiment of the present invention for purposes of understand the principles of the invention. For an example, a wind energy converter, such as windmill 10 is upheld by tower supports 18 to a height of about 20-30 feet high. The wind driven motion of multiple blades 4 is translated to horizontal axis 35 that via a L-angled gear 40 drives windmill shaft 6 to power high-pressure compressor 8 to compress air up to an elevated pressure, such as 5000-8000 pounds pressure (PSI). Vane 25 catches the breeze to pivot the spinning blades mechanism of the windmill to always faces the wind. It should be noted that windmill 10 is a “direct drive” device, as the term is used herein, that is, the energy from the wind is not converted to electrical energy prior to being conveyed to air compressor 8. Air-line 12 carries the compressed air to air tank(s) 14 where it is stored until needed. When the compressed air is needed, regulator 16, in this embodiment, is used to produce air at about 150-200 PSI for shop or other type of low pressure use devices. One of the most important uses for the wind produced pressured air is to power air driven devices, such as air motors or air machines 30. Or, as an example of combined use of electric and air motors, the high-pressure compressed air also is sent to air motor A/C generator 22 to produce electricity when needed for immediate home or shop use or, if desired, to be sent to the grid for a rebate. Additionally, extra compressed air also powers a connected D/C air generator to charge numerous batteries to store power that could be inverted to A/C power or can be used as D/C power. The pressured air can run entire homes or businesses without the need for any electricity when all of their motors are air-motors. Significantly, the high-pressure air can be stored until needed for any or all of these uses. This means that the production of electricity does not require any batteries for electricity storage and does not require any connection to the grid.

A typical horizontal-axis wind turbine, by far the most common way to harness energy from the wind, was used above as a simple way of illustrating the principles of the invention. The vertical-axis turbine was also mentioned as a way to capture wind's energy. In fact, vertical-axis mills are simpler and more effective in chaotic wind environments. Other advantages of vertical-axis mills include placing the generator and gearbox at ground level for easier maintenance, and a smaller width allows turbines to be placed closer together. There are however, several other mechanisms that could be used to practice the instant invention. High-Altitude mills can capture the steady and strong high-altitude winds. Essentially these mills constitute a small wind turbine sitting inside a large helium-filled body, the whole apparatus floats at approximately 2,000 feet skyward. This high-flying windmill is anchored to a mobile ground station by load-bearing tethers and a copper cable to transmit electricity. To maximize efficiency, the mills can move up and down and steer itself into strong wind gusts. They set up in less than a day, and generate twice as much power as a similarly rated ground turbine. These high-flying windmills could be the answer to providing consistent power in remote communities where installing standard turbines. There are horizontal-axis wind turbines that are surrounded by a specially designed shroud that funnels incoming wind to increase the turbine's efficiency. And, in places like Scotland that has constant offshore winds relatively cheap kite power systems are being used. There are mills that simulate the fast-beating wing movements of hummingbirds. A hummingbird's figure-8 wing movement creates substantial lift and is extremely stable, even during turbulent wind conditions. Then there are turbines designed to withstand the violent, destructive winds of hurricanes. There are also mills that are placed at the bottom of a specially engineered building that funnels wind down to ground level from dozens of feet in the air. One of the most interesting is the Windstalk Conceptual Generator that is essentially a very tall pole, and works by bending and swaying in the wind. That bending motion generates energy through the property of piezoelectricity. Essentially, the stretching and contracting that happens when the stalk bends creates electrical currents. And then there is a micro-generator able to fit in a backpack that uses light breezes to produce power. It's designed to be a small portable charger used in emergency situations or in rural areas without guaranteed access to electricity. The design is simple: a lightweight horizontal beam attached to springs, that can freely move up and down. When exposed to wind, the beam starts rapidly moving up and down. Because of small magnets placed on and below the beam, this rapid movement generates a small amount of electricity. It is simple to build and operate and is made of inexpensive and simple materials. It could be in every car's emergency kit. It also has some survival applications since it can also be used to power lights and other small electronic devices in small rural villages and communities without permanent electricity.

There is no question that the combination of structures that constitute the present invention is an innovation sufficiently novel and nonobvious to qualify for a patent. Windmills and batteries were used since the late 1800 hundreds and early 1900 hundreds, respectively. Windmills were used, especially in rural areas, first to pump water and eventually to generate electricity. Without a way to store the excess electricity, the windmills would have to be turned off when the amount of electricity needed was generated. As soon as storage batteries became commonly available, they were used to store excess electricity generated by the windmills. This was an electrical economy for the famers and other user, but it was an expensive one. For safety, batteries must be located in a well-ventilated space and isolated from living areas and electronics, as they contain dangerous chemicals and emit hydrogen and oxygen gas while being charged. In addition, these batteries must be protected from temperature extremes and located in a space that has easy access for maintenance, repair, and replacement. Since that time there has been about a generation of the use of windmills for generating electricity supplemented by batteries for the storage of excess electricity. Once electric lines became more abundant, many windmill/battery users, became connected to the grid as an outlet for the excess energy produced by their windmill. A grid-connected system requires balance-of-system equipment that allows the safe transmission of electricity to waiting loads and to comply with the power provider's grid-connection requirements. Also required is power conditioning equipment, safety equipment, and meters and instrumentation at a substantial cost.

After nearly a century of the difficult, problematic and dangerous use of electric power, the present inventor designed his invention to eliminate the necessary use of either batteries or grid connection, saving users substantial amounts of money and work, as well as eliminating the safety concerns that are present with battery or grid systems. His invention also provides for the elimination of electricity generation and use by switching to the environmentally friendly use of air motors. Obviously, the problems have not been previously recognized as the problems exist to the present day. Thus, it is obvious that there has been no reason to create the combination of the present invention; and even though the combination would have been a technologically possible combination of known prior art elements that constitute the present invention, that is not sufficient to render the claimed invention obvious, as the results have certainly not have been predictable to one of ordinary skill in the art. United States v. Adams, 383 U.S. 39, 51-52, 148 USPQ 479, 483-84 (1966). Even though windmills, air compressors, storage tanks for compressed air, generators, and air motors were known, and there was no evidence of undue technical hurdles or lack of a reasonable expectation of success, the combination was nevertheless not obvious because the failings in the prior art existing systems, that had prompted the present modification, had not been recognized. Thus, there would have been no reason to modify the initial combinations, even though the modification could have been done. In re Omeprazole Patent Litigation, 536 F.3d 1361, 87 USPQ2d 1865 (Fed. Cir. 2008). The Federal Circuit affirmed the district court's decision that the claimed invention was not obvious. Even though the elements of the combination were known, and there was no evidence of undue technical hurdles or lack of a reasonable expectation of success, the formulation was nevertheless not obvious because the flaws in the prior combinations that had prompted the modification had not been recognized. Thus, there would have been no reason to modify the initial combination, even though the modification could have been done.

With reference to FIGS. 1 and 2, the operation of the system will now be explained. The wind energy converter, in this example, windmill 10, captures the kinetic. energy of atmospheric wind to drive compressor 8 that compresses air converting it to potential energy. The compressed air is then stored in high-pressure air containers that act as storage devices for the high-pressure air. This system can be easily upgraded or scaled up or down. Depending on the immediate need for energy the high pressure air can be stored in storage tanks 14 for future use or alternatively or simultaneously, the potential energy of the high pressure air can drive a large number of air motors 30 or machines 24 (as described in detail above) eliminating the need for electricity. Or the potential energy of the high-pressure air can be used to drive air generator 22 to generate clean green energy to be used in DC form or converted to AC. The green electric energy can be stored in storage batteries 42 from whence it can be used by DC power users 48 directly or they can be converted for AC uses 46. Additionally, any green electrical power that is not needed can be sent back to the electrical power grid.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. The present invention is not limited to the described methods, embodiments, features or combinations of features but includes all the variations, methods, modifications, and combinations of features within the scope of the appended claims. The invention will be limited only by the claims.

What is claimed is,:

1. A system for generating and storing energy, comprising:
at least one wind energy converter,
at least one compressor,
at least one storage device,
at least one an air generator;
such that said at least one wind energy converter drives said at least one compressor to produce compressed air,
such that said at least one storage device stores the compressed air,
such that the stored compressed air drives an air generator to produce clean green electricity,
wherein the need for electricity and electrical appliances is eliminated.

2. The invention of claim 1, further comprising at least one air-driven device driven by said compressed air.

3. The invention of claim 2 wherein said at least one air-driven device is at least one air motor.

4. The invention of claim 2 wherein said at least one air generator is an A/C air generator.

5. The invention of claim 3 wherein said at least one air generator is a D/C air generator.

6. The invention of claim 5 wherein said at least one D/C air generator charges electric storage batteries.

7. The invention of claim 1 wherein said at least one air-driven device is at least one motorized air tool

8. The invention of claim 1 wherein said at least one wind-energy convertor is a horizontal axis windmill.

9. The invention of claim 1 wherein said at least one wind-energy convertor is a vertical axis windmill.

10. The invention of claim 1 further comprising an electrical controller computer for automatically controlling operation of the system.

11. A method of generating and storing energy, the method comprising the steps of:
driving, by at least one wind energy converter, at least one compressor;
compressing air by said at least one compressor producing compressed air;
storing the compressed air in least one storage device;
using the stored compressed air to drive at least one an air generator by the stored compressed air to produce clean green electricity;
wherein the need for electricity and electrical appliances is eliminated.

12. The method according to claim 11 further comprising, driving an at least one air-driven device by the compressed air.

13. The method according to claim 11 further comprising, having one air-driven device being at least one air motor.

14. The method according to claim 11 further comprising, having one air-driven device being at least one A/C air generator.

15. The method according to claim 11 further comprising, having one air-driven device being at least one D/C air generator.

16. The method according to claim 15 further comprising, charging said at least one D/C air generator by electric storage batteries.

17. The method according to claim 1 further comprising, having one air-driven device being at least one motorized air tool.

18. The method according to claim 1 further comprising, having at least one wind-energy convertor being an horizontal axis windmill.

19. The method according to claim 1 further comprising having an electrical controller computer automatically controlling operation of the method.

20. A machine, comprising:
a combination of mechanisms that capture and convert wind energy and store the converted energy until needed, having:
at least one wind-energy capturing mechanism,
at least one compressor,
at least one storage tank for storing pressured air, and
at least one air driven device;
such that said at least one wind energy capturing mechanism drives said at least one compressor converting kinetic energy of wind into potential energy of compressed air,
such that said at least one storage tank stores the compressed air,
such that when needed the compressed air drives said at least one air-driven device,
such that said at least one wind-energy capturing mechanism generates compressed air potential energy, that is stored until needed for the clean generation of electricity or for continuous running of air powered devices that completely eliminates the need for electric generators, batteries and electric motors.
